(19) United States
(12) Patent Application Publication
(10) Pub. No.: US 2003/0231944 A1
(43) Pub. Date: Dec. 18, 2003

(54) Wheel-lift assembly for wreckers

(76) Inventors: Jeff Weller, Greencastle, PA (US); Steven Harris, Martinsburg, WV (US); David F. Humphries, Greencastle, PA (US)

Correspondence Address: MCDERMOTT, WILL & EMERY, 600 13th Street, N.W., Washington, DC, 20005-3096, US

(21) Appl. No.: 10/411,394

(22) Filed: Apr. 11, 2003

Related U.S. Application Data
(60) Provisional application No. 60/371,415, filed on Apr. 11, 2002.
(60) Provisional application No. 60/396,740, filed on Jul. 19, 2002.

(51) Int. Cl. B62D 43/00

(52) U.S. Cl. 414/463

(57) ABSTRACT

An improved wheel-lift assembly is provided for towing vehicles on a wrecker. The wheel-lift assembly is adapted to be mounted on the rear deck of the wrecker. The wheel-lift tow assembly includes a relatively thin crossbar assembly, a pair of moveable support arms which are connected to a pair of lifting arms, and multiple hydraulic cylinders. The hyrdraulic cylinders control the position of the crossbar assembly. Two of the hydraulic cylinders are connected to the support arms, and thereby control the position of the lifting arms. The wheel-lift assembly includes over-center locking devices for securely locking the lifting arms in place during towing. The wheel-lift assembly may also include a mechanism for preventing excessive movement of the tow assembly, and it can be used in combination with an adjustable truck body.

### CROSS-REFERENCE TO RELATED APPLICATIONS

The present application is based on U.S. Provisional Application Serial No. 60/371,418, filed on Apr. 11, 2002, entitled “Improved Underlift Assembly for Tow Trucks” by the inventors of the present application. The present application is further based on U.S. Provisional Application Serial No. 60/396,740, filed on Jul. 19, 2002, also entitled “Improved Underlift Assembly for Tow Trucks,” and also by the inventors of the present application.

### FIELD OF THE INVENTION

The present invention relates generally to tow trucks or “wreckers” for towing a vehicle, and more particularly to a tow assembly for wreckers which engages and lifts the two front wheels or the two rear wheels of the vehicle to be towed.

### BACKGROUND OF THE INVENTION

From time to time, automobiles must be moved by external force or without the assistance of a driver for the automobile. These situations may arise when automobiles become disabled due to, for example, mechanical or electrical malfunctions. At other times, automobiles may be deemed to be parked illegally. At still others, repossession of the automobile may be desired by a creditor due to lack of payment or otherwise. Wreckers for towing automobiles by lifting either the front or rear wheels off the ground have long been used for these situations. The more modern and readily used types of wreckers or are known as “underlift” or “wheel-lift” wreckers. An underlift wrecker engages and lifts the vehicle to be towed at its frame members, and a wheel-lift wrecker engages and lifts the vehicle to be towed at its front or rear wheels, or tires.

Wheel-lift wreckers generally employ a telescoping or folding main crossbar element attached to the rear of the truck and extending rearwardly from or out beyond the truck's rear deck (the space between the rear of the cab and the rear bumper). The crossbar element represents the main lifting or leverage component for lifting one end of the vehicle to be towed (target automobile). Such wreckers also use a wheel engaging apparatus for engaging and holding the front or rear wheels of a vehicle. The wheel engaging apparatus (wheel cradle) typically includes a crossbar (also referred to as a “wheel boom”) pivotally attached to the end of a tow bar or main boom, and wheel retainers or lifting arms for engaging the wheels of the vehicle to be towed. When positioning the system for towing, the crossbar is maneuvered into a position against the tread of the tires and the lifting arms are then locked into a position securing the tires in place against the crossbar.

Examples of such prior art wheel-lift/underlift tow systems are found in U.S. Pat. No. 4,564,207 (the “'207 Patent”) to Russ et al., entitled “Hydraulic Wheel Lift System for Tow Vehicles,” dated Jan. 14, 1986. The '207 Patent employs a loosely fitting “sock” to adjust the wheel cradle. This “sock” of the '207 Patent is not secure to the lifting arm and allows only a single adjustment of the wheel cradle. When a target automobile has been loaded onto a tow assembly, bumpy and uneven roads may be encountered. When such terrain is encountered, the towed vehicle's suspension sometimes allows vertical movement (“jounce”) toward the crossbar assembly, thus increasing chances that the oil pan or transmission of a towed vehicle might be damaged. The thicker the crossbar assembly of the wrecker, the greater the chances that the oil pan or transmission could be damaged upon transport of the target automobile.

Another example of a prior art wheel-lift tow system is found in U.S. Pat. No. 6,139,250 (the “'250 Patent”) to Nolasco, entitled “Wheel Lift with Laterally Movable, Rotatable Swivel Arm Wheel Scoops,” dated Oct. 31, 2000, the entire disclosure of which is hereby incorporated by reference herein. As indicated hereinabove, the oil pan or transmission of a target automobile can possibly be damaged during towing if the automobile is not secured within the wheel cradle. The '250 Patent lacks efficient safety or locking mechanisms for securing the tires of the target automobile to the wheel cradle.

### SUMMARY OF THE INVENTION

The present invention relates to an improved wheel-lift assembly that includes an adjustable wheel engaging apparatus, or wheel cradle. The present invention includes a wheel cradle that is adjustable in several positions, thus allowing for adjustment for various sizes of automobiles and tires. The adjustable wheel cradle of the present invention reduces the chance that the oil pan or transmission of a target automobile will be damaged during transport. The adjustable wheel cradle is formed using a pair of substantially L-shaped rotatable lifting arms, a pair of support arms and a pivotable crossbar which form two substantially U-shaped configurations for receiving the front or rear tires of a target automobile. The L-shaped lifting arms are laterally displaceable. These lifting arms can be used to adjust the size of the wheel cradle when they are extended or shortened by sliding the lifting arms on a pair of support arms. The present invention also includes a relatively thin crossbar assembly which further reduces the chance that the oil pan or transmission will come into contact with the crossbar assembly during transport.

The present invention further includes an over-center locking mechanism such as the type generally described in U.S. Pat. No. 5,722,810 to Young et al., entitled “Over-Center Locking Mechanism for Tow Truck Wheel-Lift or the Like,” the entire disclosure of which is hereby incorporated by reference, and in U.S. Pat. No. 6,315,515 to Young et al., entitled “Over-Center Locking Mechanism for Tow Truck Wheel-Lift or the Like,” the entire disclosure of which is hereby incorporated by reference. The over-center locking mechanism used in the present invention automatically secures the lifting arms of the wheel cradle in place. This overcenter locking mechanism requires no manual engagement or extra steps beyond the normal procedure for engaging, lifting and towing the target automobile. Engagement of the lift arms and crossbar assembly with the wheels of the vehicle to be towed automatically sets the overcenter locking mechanism without the continued support of the linear actuators. The present invention further provides a tilt lock-out which may serve as either a back-up or primary security system. The tilt lock-out, like the over-center lock, is automatic and requires no manual engagement.

Another aspect of the present invention is a mechanism for preventing excessive movement of the wheel-lift assembly, as generally described in U.S. Pat. No. 5,672,042 to Bartel, entitled “Underlift Assembly Tow Trucks,” the entire disclosure of which is hereby incorporated by reference. A further aspect of the present invention is the improved wheel-lift in combination with an adjustable truck body, as described in U.S. Pat. No. 6,290,450 to Humphries, et al., entitled “Universal Wrecker Sub-Frame and Body Panel Assemblies,” the entire disclosure of which is hereby incorporated by reference. Still another aspect of the present invention is the improved wheel-lift together with an adjustable truck body having a lightweight body assembly, as described in U.S. Pat. No. 5,839,775 to Young et al., entitled “Lightweight Rust-Resistant Body Assembly for Tow Trucks and a Method of Manufacture,” the entire disclosure of which is hereby incorporated by reference. The Young, Humphries and Bartel patents are all assigned to the assignee of the present invention, Jerr-Dan Corp.

### BRIEF DESCRIPTION OF THE DRAWINGS

Reference is made to the attached drawings, wherein elements having the same reference numeral designations represent like elements throughout, and wherein:

FIG. 1 is a perspective view of a wrecker incorporating the wheel-lift tow assembly of an embodiment of the present invention.

FIGS. 2A-2C are sequential side views of the wheel-lift tow assembly of an embodiment of the present invention as the wheel cradle is lowered in preparation for towing.

FIG. 3 is a top perspective view of the wheel cradle of an embodiment of the present invention as shown in FIG. 2C.

FIGS. 4A-4C are sequential top views of an inventive wheel cradle's lifting arms as they are moved into position for towing.

FIG. 5A is a perspective view of the wheel-lift of an embodiment of the present invention showing the wheel cradles after full rotation of the lifting arms of the wheel-lift tow assembly.

FIG. 5B is a perspective view of the slideable wheel receiving grids of an embodiment of the present invention during adjustment for the wheel size of the target automobile.

FIGS. 6-14 are sequential side views of a wrecker incorporating the wheel-lift tow assembly of an embodiment of the present invention showing the operation of the wheel-lift tow assembly.

FIG. 15 shows a side view of the wheel-lift tow assembly of an embodiment of the present invention.

FIG. 16 shows a top view of a body assembly and sub-frame assembly used with a wheel-lift tow assembly according to an embodiment of the present invention.

FIG. 17 shows a left side view of a wrecker with adjustable sub-frame and body panel assemblies used with a wheel-lift tow assembly of an embodiment of the present invention.

FIG. 18 shows a top view of another embodiment of a body assembly and sub-frame assembly used with the wheel-lift tow assembly of an embodiment of the present invention.

FIG. 19 shows a top view of yet another embodiment of a body assembly and sub-frame assembly used with the wheel-lift tow assembly of an embodiment of the present invention.

### DESCRIPTION OF THE INVENTION

The present invention is an improved wheel-lift tow assembly (also called an autoloader or self load wheel cradle) for towing vehicles with a wrecker. The wheel-lift is adapted to be mounted onto a wrecker, preferably on the rear deck.

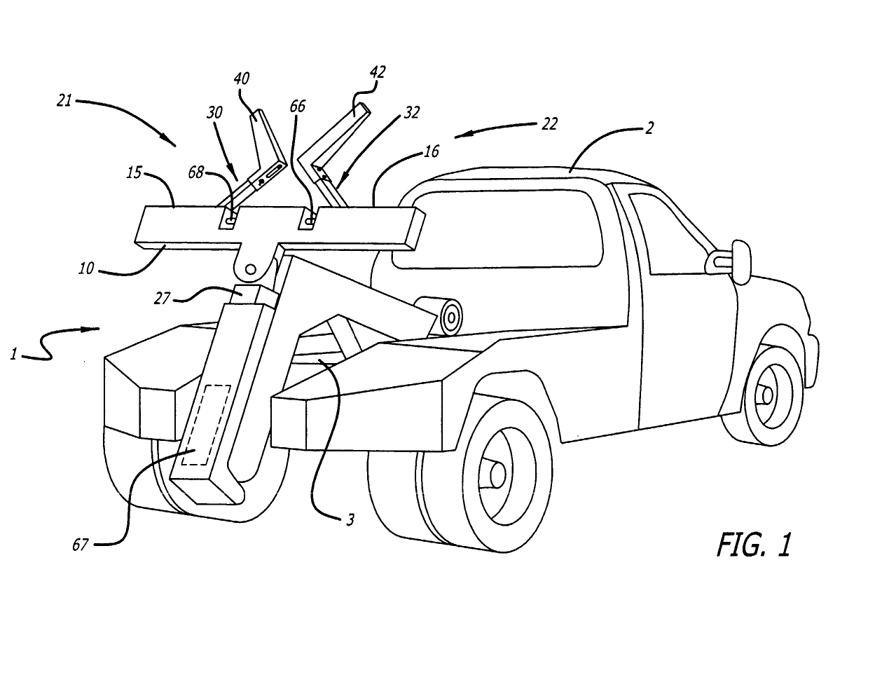

Referring now to FIG. 1, illustrated is a perspective view of a wrecker 2 incorporating the wheel-lift tow assembly of the present invention. In this view, the tow assembly 1 is stowed prior to use. The wheel-lift tow assembly 1 is adapted to be mounted on the rear deck 3 of the wrecker 2. The wheel-lift tow assembly 1 includes a crossbar assembly 10, hydraulic cylinders 66, 68, and a pair of moveable support arms 30, 32 which are connected to a pair of lifting arms 40, 42. The support arms 30, 32 are spaced apart from each other, and pivot or swivel on the crossbar 10 to prepare the lifting arms 40, 42 for use.

The crossbar assembly 10 is relatively thin, and has no bolt projections or the like. The thickness of the crossbar assembly 10 is, for example, about four (4) inches. The relatively thin crossbar assembly 10 of the present invention presents a low profile in that it is of a lesser thickness than prior art crossbar assemblies. For example, the commercial version of the tow assembly described in the '207 Patent, described hereinabove, known as the Dynamic autoloader, has a crossbar thickness of about 5-¼″ with extending projections.

The low profile of the wheel-lift tow assembly of the present invention facilitates safety and reduces the chance of damage to the target vehicle in that it lessens the possibility of the oil pan or transmission or body component of the towed vehicle engaging the crossbar assembly 10. The crossbar assembly includes two slideable wheel receiving grids 15, 16 which engage the front portions of the front or rear tires of the target automobile during towing. The crossbar assembly 10 also includes a support beam 27 which telescopes when the tow assembly is in use so that the crossbar assembly 10 may be extended for target automobiles which are at a further distance from the wrecker. The telescoping functionality is provided by a hydraulic cylinder 67 or other actuating devices. Such actuating devices may be controlled by the operator of the wrecker using controls that are within his or her reach from the driver's seat.

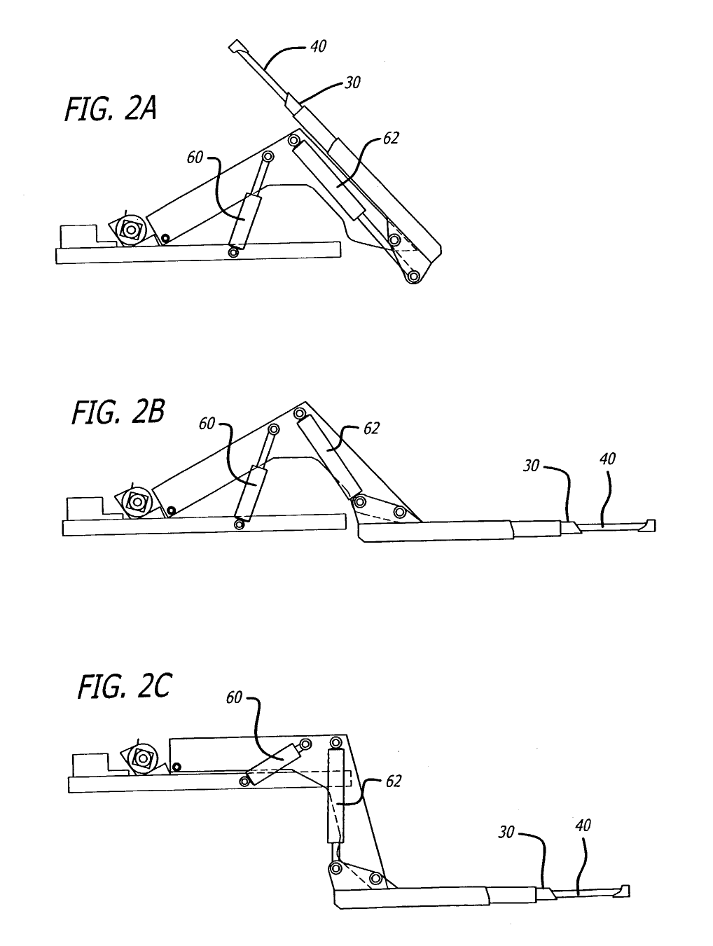

Referring now to FIG. 2A, illustrated is a side view of the wheel-lift tow assembly 1 as the tow assembly is stowed prior to use. Multiple hydraulic cylinders 60, 62 or other actuating devices are used to control the position of the crossbar assembly 10.

Referring now to FIG. 2B, hydraulic cylinders 60, 62 are used to lower and, if necessary, tilt, the wheel-lift tow assembly 1 closer to ground level. The tilting functionality is especially useful where the target vehicle is parked downhill or uphill from the wrecker. These cylinders 60, 62 also help to maintain the position of the crossbar assembly 10, and allow the wheel-lift to maintain a substantially horizontal position. For example, when the wheel lift is about 30″ above the ground, the crossbar assembly 10 is also about 30″ above the ground. Referring now to FIG. 2C, the wheel-lift tow assembly 1 is shown after it has been fully lowered.

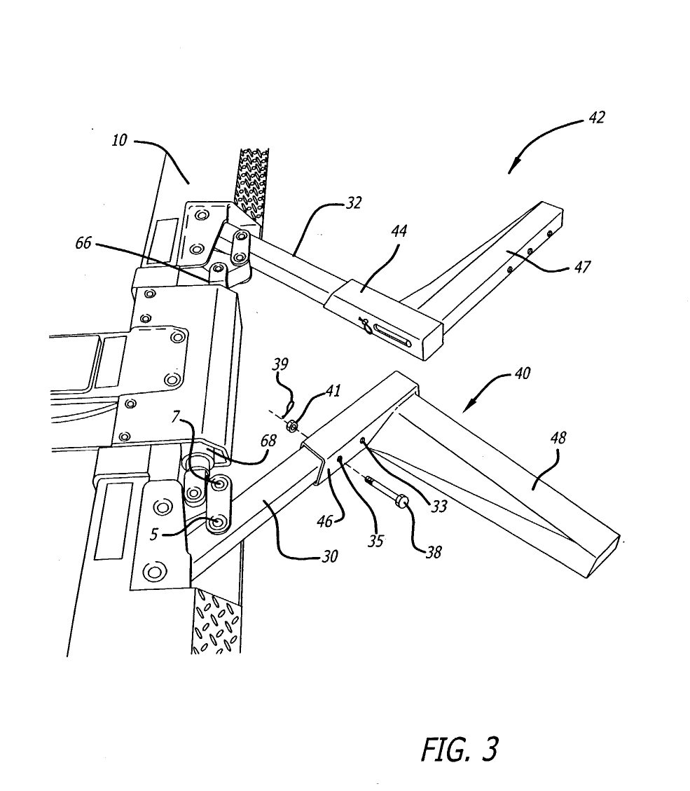

Referring now to FIG. 3, lifting arms 40, 42 include corresponding extension arm segments 44, 46 and engaging arm segments 47, 48. The extension arm segments 44, 46 are operatively connected to the support arms 30, 32. The extension arm segments 44, 46 are slideably moveable upon the support arms 30, 32. The extension arm segments 44, 46 are relatively transverse to the crossbar assembly 10 at positions disposed to fit between the front or rear wheels of a target vehicle when the wheel-lift tow assembly 1 is in operation. The width of the extension arm segments 44, 46 of each of lifting arms 40, 42 are adjusted by slideably moving the lifting arms upon the support arms, and fixing lifting arms 40, 42 relative to support arms 30, 32, as by inserting a mating pin 38 into one of several holes 33, 35 in extension arm segments 44, 46, which hole has been aligned with a hole in each of support arms 30, 32, so that the extension arm segments 44, 46 are set at a desired width responsive to the size of the tire of the target automobile. Each mating pin 38 should be secured, such as with a cotter pin 39, and jam nut 41, so that the extension arm segment does not move when the target automobile is mounted and towed. One such mating pin assembly may include a conventional cotter pin, jam nut and socket head capscrew.

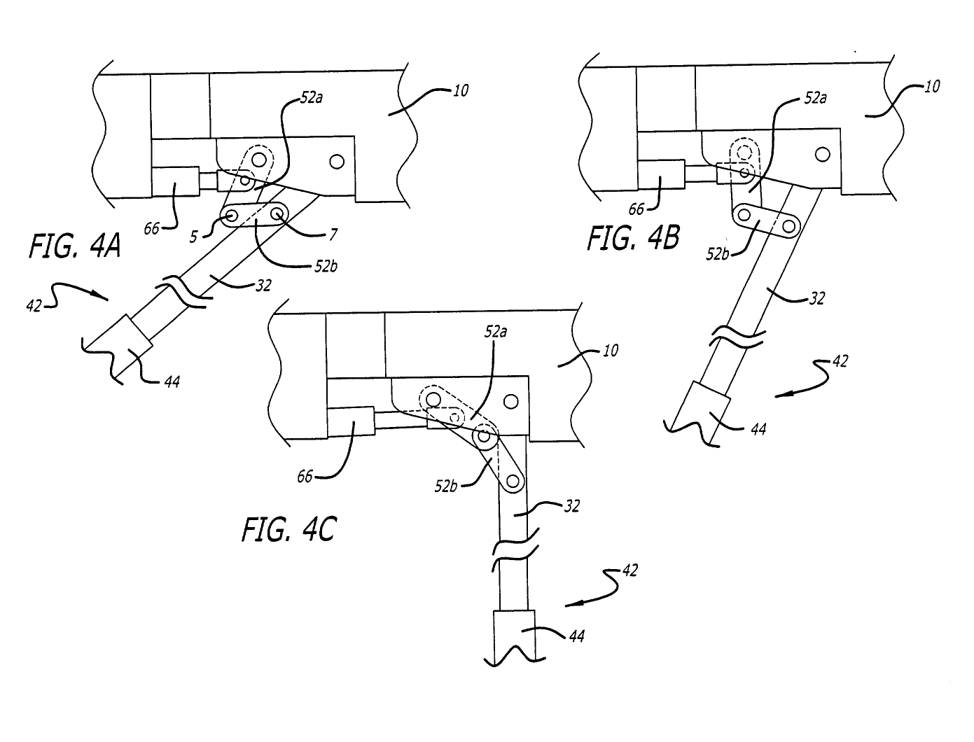

Because of the dual pivoting connections 5, 7 for the support arm 32/lifting arm 42 assembly, the pistons of the hydraulic cylinders 66, 68 travel along an arcuate path, rather than in a linear path as described in greater detail hereinbelow in connection with FIGS. 4A-4C.

Since a wrecker is often moving during normal towing operation, it is preferable that the automobile or other vehicle being towed is securely engaged with the tow assembly. The hydraulic cylinders 66, 68 enable the lifting arms 40, 42 to maintain engagement with the wheels of the towed vehicle, e.g., when the wrecker turns corners, thus promoting stability. The hydraulic cylinders 66, 68 of the improved wheel-lift of the present invention are pivotally connected to the end of each of the support arms 30, 32.

In FIG. 3, the wheel-lift tow assembly 1 has been unfolded and lowered from the wrecker nearer to ground level, so that the support arms 30, 32 and lifting arms 40, 42 would be substantially horizontal to a level ground.

FIGS. 4A-4C depict one representative side view of the wheel-lift of an embodiment of the present invention. The other side is substantially identical. Referring now to FIG. 4A, when the wheel-lift tow assembly 1 is first lowered, the hydraulic cylinder 66 near the support arm 32 has not been actuated. Referring now to FIG. 4B, the hydraulic cylinder 66 is actuated, thus rotating the lifting arm 42 outward via links 52a, 52b. The lifting arm 42 moves in an arcuate pattern until the base portion of lifting arm 42 is substantially parallel with the wrecker's length.

Referring now to FIG. 4C, as the lifting arm 42 rotates into position, the cylinder 66 pushes links 52a, 52b into an over-center position, i.e., where the pivotal joint between links 52a and 52b are located at or beyond the 180 degree point. The lifting arm 42 is locked into position by the links 52a, 52b and the lifting arm 42 cannot be forced out of position by a loss of hydraulic pressure.

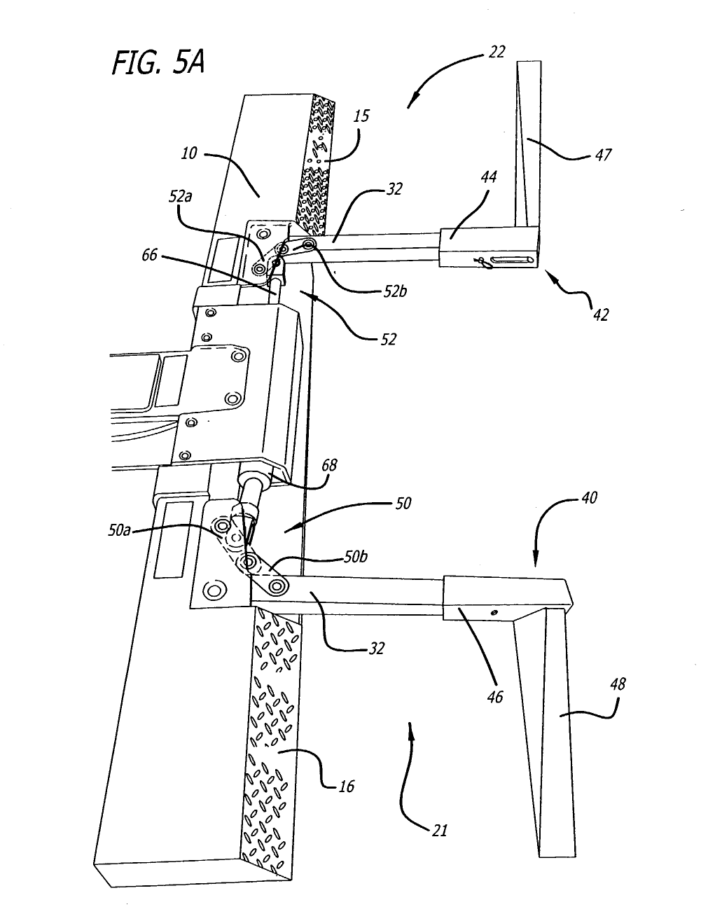

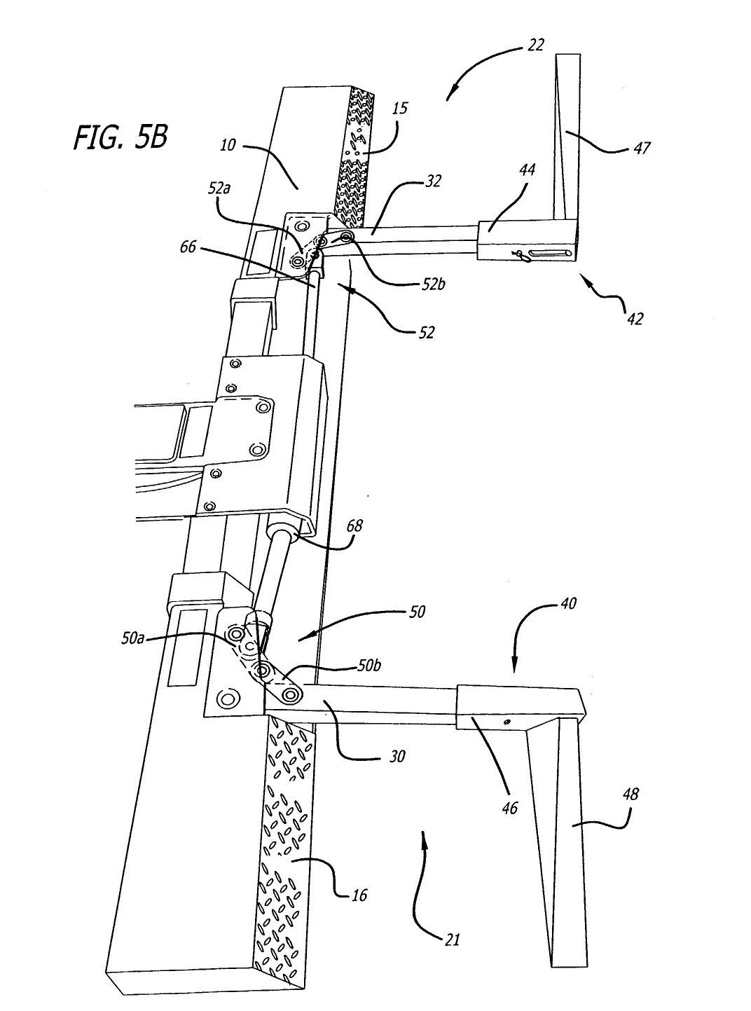

Referring now to FIG. 5A, which shows both sides of the wheel-lift of this embodiment of the present invention, over-center locking mechanisms 50 and 52 include links 50a, 50b and 52a, 52b, respectively, whereby extension of the hydraulic cylinders 66, 68 position the links 50a, 50b, 52a, 52b in a locking position, such that outward pressure by the wheels of a vehicle in tow against the engaging arm segments 44, 46 forces the links 50a, 50b, 52a, 52b toward the locking position. The locked or wheel engaging position is therefore automatically maintained without the aid of the hydraulic cylinders 66, 68, in case of a failure of hydraulic cylinders 66, 68. In other embodiments of the present invention, the over-center locking mechanisms 50, 52 are attached to wheel receiving grids that are fixed to the crossbar 10 rather than slidable, or are attached directly to the crossbar 10.

Still referring to FIG. 5A, wheel cradles 21, 22 are formed by the support arms 30, 32, the lifting arms 40, 42, and the slideable wheel receiving grids 15, 16, respectively. In the position shown, the wheel cradles 21, 22 are prepared to receive the two front wheels of the target automobile, or the two rear wheels of the target automobile.

The slideable wheel receiving grids 15, 16 automatically adjust position relative to the crossbar 10 according to the distance between the target vehicle's front or rear tires. FIG. 5B illustrates the wheel receiving grids 15, 16 when they have automatically moved outward from the center of wheel-lift 1 due to the extension of hydraulic cylinders 66, 68. During a normal towing operation, the wheel receiving grids 15, 16 move outward until support arms 30, 32 and/or extension arm segments 44, 46 of lifting arms 40, 42 contact both front tires and/or wheels of the target automobile. The present invention can include an adjustment mechanism that allows the wheel receiving grids 15, 16 to slide outward until a single tire of a target automobile is contacted. Once a single tire is contacted, the wheel receiving grids 15, 16, which have been set into motion by the hydraulic cylinders 66, 68, stop their outward expansion, and the pressure of the hydraulic cylinders 66, 68 is equalized so that the target automobile is centered onto the wheel-lift tow assembly.

When lifting arms 40, 42 contact the tires and/or wheels, they can maintain or assist retention of the tires in cradles 21, 22. In certain embodiments of the present invention, appropriate bearing surfaces (not shown) can be attached to support arms 30, 32 and/or extension arm segments 44, 46 to engage the wheels; e.g., a concave cup that bears against each respective wheel.

The wheel-lift tow assembly of the present invention is highly versatile in that the truck need not be positioned directly in front of the car in order for the tow assembly to operate properly. An automobile can be loaded onto the wheel-lift tow assembly of the present invention when the automobile is directly behind the wheel-lift tow assembly so that an angle of approximately zero degrees exists between the driver's side of the wrecker and the left side of the target automobile. A target automobile can be loaded onto the wheel-lift tow assembly also when the left side of the target automobile and the left side of the wrecker are at substantially a ninety degree angle from one another. A hydraulic cylinder 67 in the telescoping central support beam 27 of the crossbar assembly allows the telescoping central support beam 27 to be extended. As discussed above, the size of the wheel cradles 21, 22 can be adjusted by adjusting the lifting arms 40, 42 to fit the tire size.

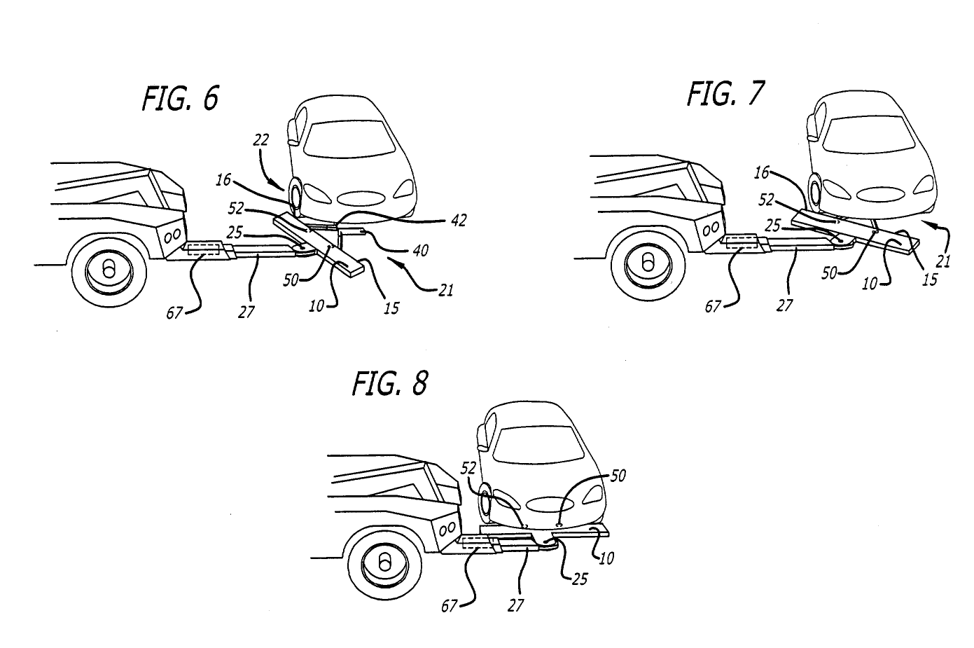

The operation of the wheel-lift of an embodiment of the present invention will now be described with reference to FIGS. 6-14. As shown in FIG. 6, a cradle is prepared for one tire of the target automobile. In this illustration, the automobile's front right tire is inserted into the cradle. When the crossbar assembly 10 touches the front right tire, the pivot 25 in the crossbar assembly 10 permits the wheel cradles 21, 22 to be lined up with the front tires of the target automobile so that the automobile can be towed.

Wheel cradles 21, 22 are formed by the lifting arms 40, 42 and the wheel receiving grids 15, 16 when the wheel-lift tow assembly 1 is in operation. As previously described, over-center locking devices 50, 52 ensure that the lifting arms 40, 42 of the formed wheel cradles 21, 22 are safely maintained in their rotated position even if a hydraulic cylinder fails. Referring now to FIG. 7, after the right front tire of the target automobile is within the frame of the wheel cradle 21, the wrecker operator moves the wrecker in reverse. The crossbar assembly 10 contacts the right front side tire and begins to pivot around the pivot point 25, thus turning the wheel cradles 21, 22 so that the openings for wheel cradles 21, 22 are aligned with the front tires (or rear tires) of the target automobile.

Referring now to FIG. 8, the wrecker operator continues to move the truck in reverse until the crossbar assembly 10 contacts the left front tire of the automobile. The pivot point 25 of the crossbar assembly 10 wheel-lift tow assembly 1 is centered with the tires of the automobile.

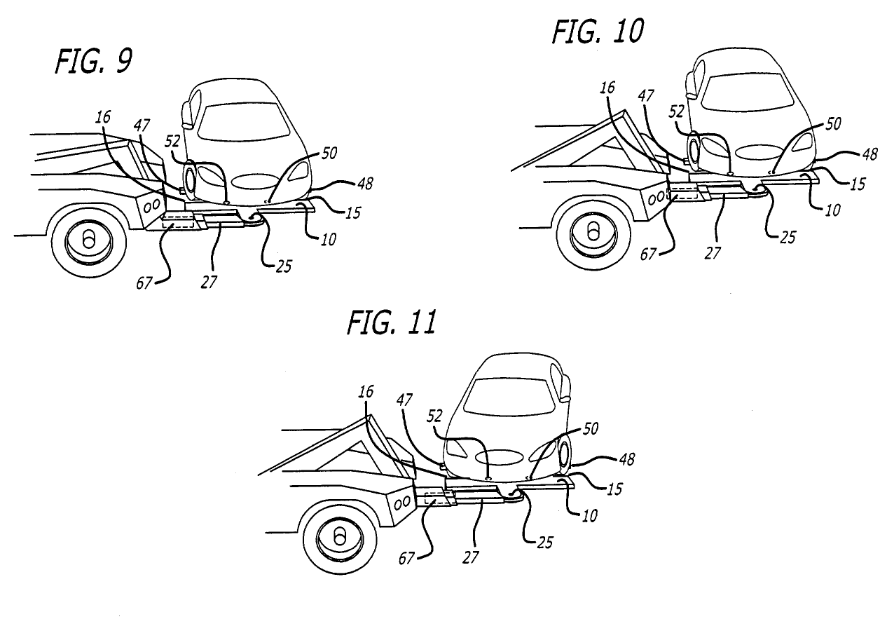

Referring now to FIG. 9, over-center locking devices 50, 52 are automatically activated when the lifting arms 40, 42 are perpendicular to the wheel receiving grids 15, 16 and hydraulic pressure is applied to cylinders 66, 68. The wheel receiving grids 15, 16 expand outward due to the hydraulic pressure, as explained above, until the wheel cradles 21, 22 gently contact both front tires of the target automobile. As also explained above, once a single tire is contacted, the wheel receiving grids 15, 16 stop their outward expansion, and the pressure of the hydraulic cylinders 66, 68 is equalized so that the target automobile is centered onto the wheel-lift tow assembly.

Referring now to FIG. 10, the operator raises the telescoping central support beam by activating a hydraulic cylinder in the wheel-lift tow assembly. Accordingly, the front portion of the target automobile is also raised. The operator uses controls within reach of the driver's seat to control the cylinders. The crossbar pivot 25 is centered with the automobile as shown in this illustration.

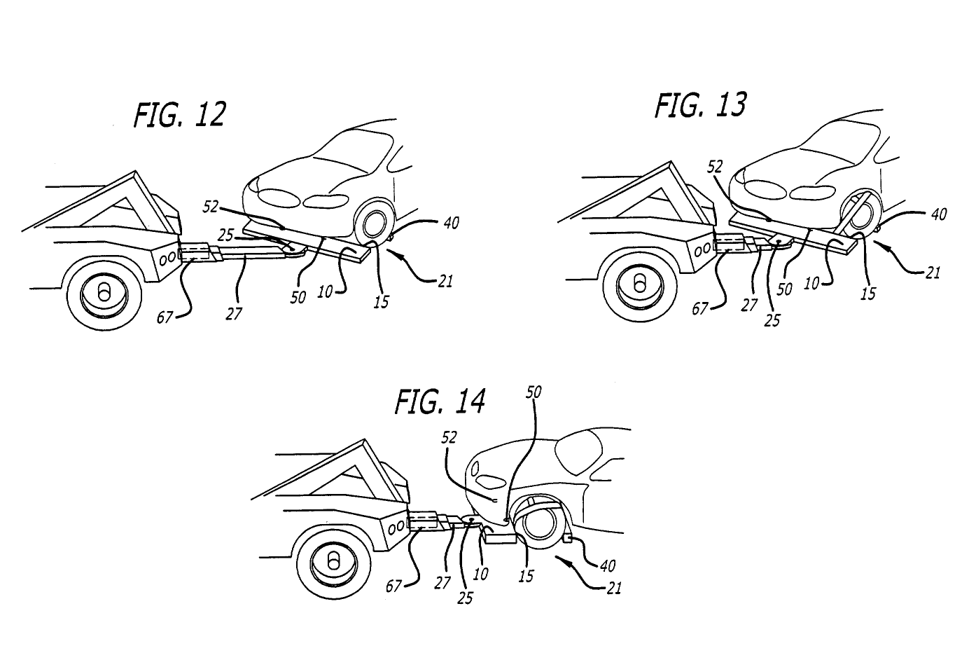

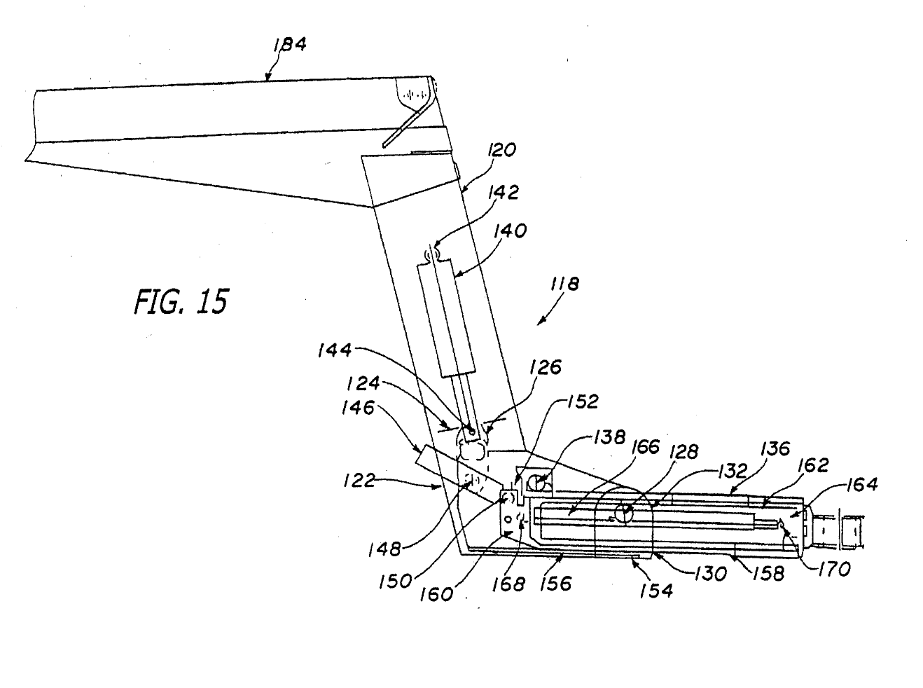

Referring now to FIG. 11, the target automobile has been prepared for towing. The operator now moves the wrecker forward, while the target automobile begins to pivot at its rear axle. Referring now to FIG. 12, the wrecker operator continues to move forward, and the target automobile, which is now securely mounted on the wheel-lift tow assembly, begins to straighten and follow the wrecker.

Referring now to FIG. 13, the two truck operator retracts the telescoping central support beam 27 and adds all appropriate towing and safety attachments. For example, a strap may be used to further secure or tie down the wheels of the target automobile to the wheel-lift tow assembly in a conventional manner. The strap could be adjusted with a ratchet mechanism. Another example of such an additional towing or safety attachment is a tow ball attachment that allows the wrecker operator to recover and tow trailers requiring a tow ball hookup.

Referring now to FIG. 14, the wheel-lift tow assembly pulls the car to the desired location.

Referring now to FIG. 15, disclosed is another embodiment of the wheel-lift tow assembly of the present invention. This embodiment of the wheel-lift tow assembly incorporates a mechanism for preventing excessive movement, such as that described in U.S. Pat. No. 5,672,042, which has been incorporated by reference herein. The wheel-lift assembly 118 has a support arm 120 that is coupled to the wrecker. A base 122 is coupled at a first end 124 to the support arm 120. A boom base 126 is pivotally attached to the base 122 at a first pivot point 128. The first pivot point 128 is preferably located adjacent to a second end 130 of the base 22 that is opposite to the first end of the base 124, and adjacent to a first end 132 of the boom base 126. The boom base 126 has a first end 132 and a second end 134. The second end 134 is located nearer to the first end of the base 124 than is the first end of the boom base 132. A boom 136 is pivotally attached to the boom base 126 at a second pivot point 138 that is preferably located further from the first end of the boom base 132 than the first pivot point 128. A first actuator 140 is coupled to the support arm 120 by a pivot pin 142 and the boom base 126 by a pivot pin 144. The first actuator 140 pivots the boom base 126 with respect to the support arm 120. A second actuator 146 is coupled to the boom base 126 by pivot pin 148 and the boom 136 by pivot pin 150. The second actuator 146 pivots the boom 136 with respect to the boom base 126. Vehicle engaging attachments, such as the inventive wheel-lift 1, are connected to a distal end of the boom which may engage the target automobile's frame or wheels.

In this embodiment of the wheel-lift tow assembly of the present invention, a first stop 152 is attached to the boom base 126. The first stop 152 is preferably located between the second pivot point 138 and the second end of the boom base 134. A second stop 154 is attached to the boom base 126. The second stop 154 is preferably located below the first pivot point 128. The first and second stops 152, 154 restrict the pivot range of the boom 136 with respect to the boom base 126. The first stop 152 and the second stop 154 restrict the boom 136 from pivoting below a line formed by a lower edge of the boom base 156.

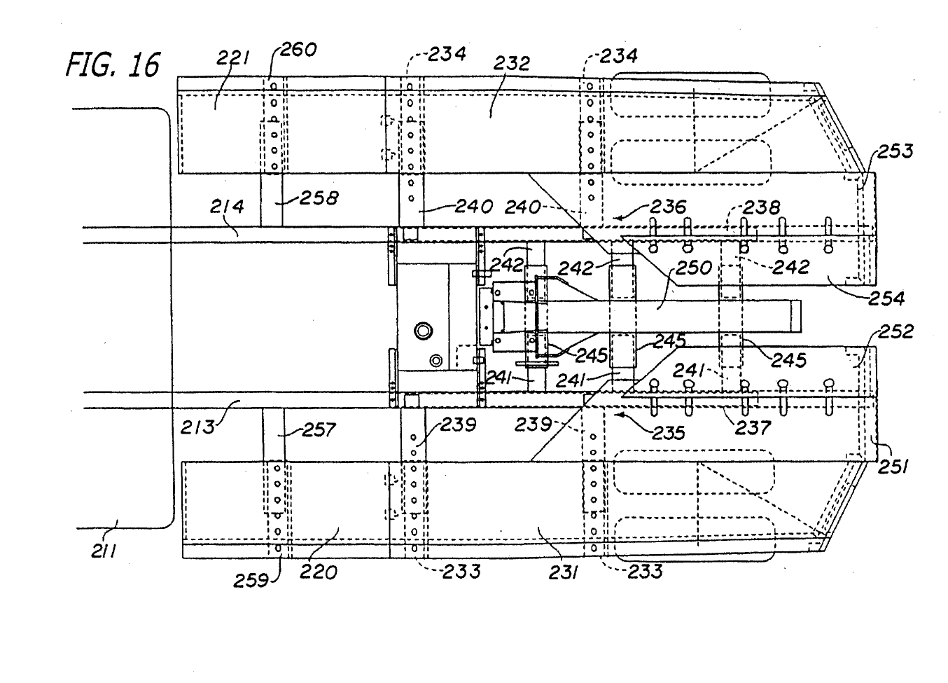

FIG. 16 shows a top view of the body assembly and sub-frame assembly of another embodiment of the present invention. The body assembly comprises left and right body panels 231 and 232, each with a pair of mounting brackets 233 and 234, respectively. The left and right body panels mount on a body sub-frame assembly, which comprises left and right sub-frame members 235 and 236. Each sub-frame member comprises a sub-frame rail 237, 238, a pair of body support brackets 239, 240, and three sub-frame brace tubes 241, 242. The left and right sub-frame members are held together as the body sub-frame assembly via three sub-frame brace sleeves 245. Except where expressly stated otherwise, the left and right body panels 231 and 232, and the left and right sub-frame members 235 and 236, are mirror images of each other.

As illustrated in FIG. 16, the body sub-frame assembly is assembled with two opposing sub-frame members 235 and 236 connected together with their respective sub-frame brace tubes 241 and 242 inserted into respective sub-frame brace sleeves 245. Each of the three sub-frame brace tubes 241 of the left sub-frame member 235 is inserted into one end of a sub-frame brace sleeve 245. Each of the three sub-frame brace tubes 242 of the right sub-frame member 236 is inserted into the other end of the sub-frame brace sleeve 245 opposite to a corresponding subframe brace tube 241. The sub-frame brace tubes 241, 242 are inserted a predetermined distance into the sub-frame brace sleeves 245.

The sub-frame brace tubes 242 are fixed to the sub-frame rail 238 of the right sub-frame member 236, and the sub-frame brace tubes 241 are fixed to the sub-frame rail 237 of the left sub-frame member 235. The predetermined distance that the sub-frame brace tubes 241, 242 are inserted into the sub-frame brace sleeves 245 is set such that the sub-frame rails 237 and 238 line up with the chassis rails 213 and 214, respectively. The sub-frame brace tubes are welded into the sub-frame brace sleeves in that position. The body sub-frame assembly is then ready for mounting on the desired chassis.

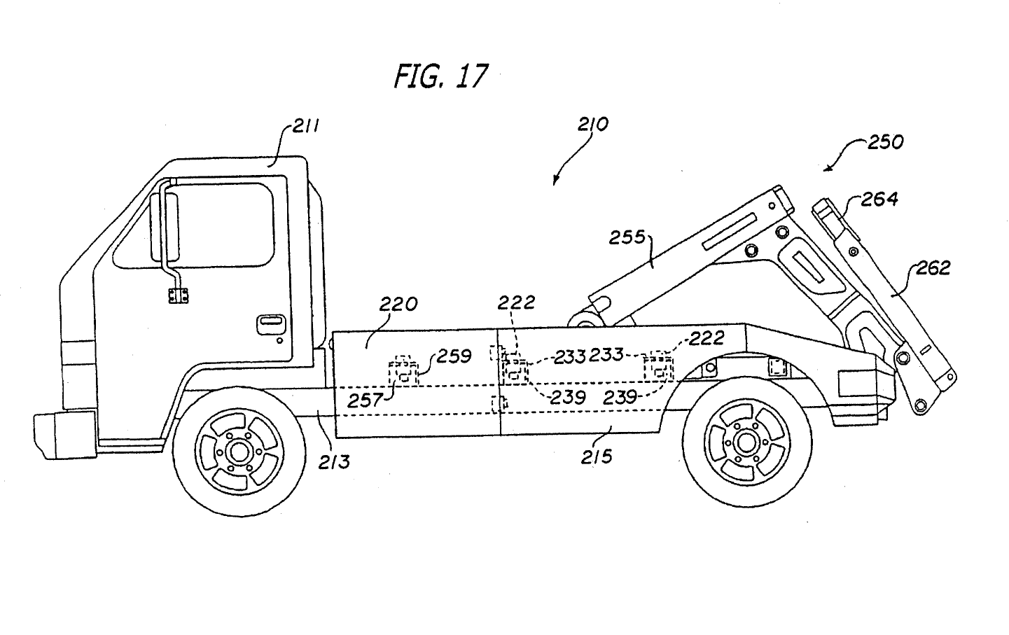

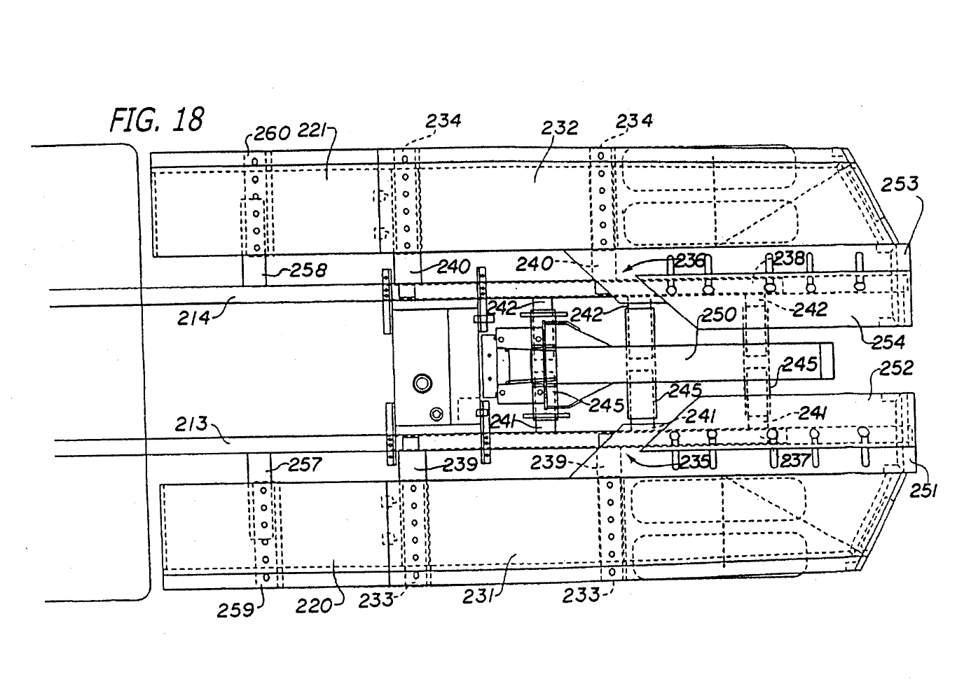

FIG. 17 shows a left side view of a wrecker 210 equipped with adjustable sub-frame and body panel assemblies in accordance with the exemplary embodiment of the present invention. The wrecker also includes a lift assembly for towing a disabled vehicle. A wide variety of different lift assembly embodiments can be employed with the adjustable sub-frame and body panel assemblies of the present invention, and following description illustrates one such embodiment. The wrecker comprises a chassis 212, with a cab 211 and lift assembly 250 mounted thereon. The lift assembly includes a main boom 255 (or crossbar assembly) pivotally mounted to the truck chassis with a hydraulic system (not shown) for raising, lowering, extending, and/or retracting the main boom 255. The lift assembly 255 further includes an extension boom 262 pivotally connected to the end of the main boom 255 with a hydraulic system (not shown) for rotating the extension boom 262 up and down. A wheel grid assembly 264 is attached at the end of the extension-boom 262 for engaging the front or rear wheels of a vehicle to be towed.

The body panel 215 includes the pair of mounting brackets 233, each engaging a body support bracket 239 of the left sub-frame member. The body panel is secured to the sub-frame member by bolting the mounting brackets 233 to the respective body support brackets 239 with bolts 222. A length spacer panel 220 is cut to cover a portion of the chassis between the cab 211 and the body panel 215.

For example, comparing FIG. 16 to FIG. 18, the body sub-frame assembly of FIG. 16 is mounted on a wide truck chassis, compared to the body sub-frame assembly of FIG. 18, mounted on a narrower truck chassis. The sub-frame brace tubes 241, 242 of the sub-frame members in FIG. 18, are partially inserted into the sub-frame brace sleeves 245, resulting in a wider positioning of the sub-frame rails 237 and 238 to line up with the wider configuration of chassis rails 213 and 214, respectively. Comparatively, the sub-frame brace tubes 241, 242 of the sub-frame members in FIG. 18, are fully inserted into the sub-frame brace sleeves 245, resulting in a narrower positioning of the sub-frame rails 237 and 238 to line up with the narrower configuration of chassis rails 213 and 214, respectively. The sub-frame assembly is thereby adjustable to fit a variety of different chassis widths.

The body sub-frame assembly supports the left and right body panels 231 and 232 via the body support brackets 239 and 240, respectively. The body support brackets 239 are fixed to the left sub-frame rail 237 on the opposite side from the sub-frame brace tubes 241, and the body support brackets 240 are fixed to the right sub-frame rail 238 on the opposite side from sub-frame brace tubes 242. The mounting brackets 233 and 234 of the left and right body panels align with the respective body support brackets 233 and 234. The mounting brackets 233 and 234, and the body support brackets 239 and 240, each have a series of holes at a predetermined spacing along their length. The predetermined spacing is set such that the holes of a given mounting bracket line up with the holes of the corresponding body support bracket in a manner allowing for various lateral mounting positions for the body panel on the body sub-frame assembly. The various lateral positions are designed to accommodate a number of standard truck chassis and cab widths. Each body panel is positioned on the corresponding body support brackets at a desired lateral position with respect to the cab width and width between outer rear wheels, and bolted in that position.

For example, again comparing FIG. 16 to FIG. 18, the left and right body panels 231 and 232 of FIG. 16, are mounted on a wide truck chassis, compared to the left and right body panels 231 and 232 of FIG. 18, mounted on a narrower truck chassis. The mounting brackets 233 and 234 of the body panels in FIG. 16, are partially inserted over the respective body support brackets 239 and 240 of the respective sub-frame members 235 and 236, resulting in a wider positioning of the body panels with respect to the truck cab and chassis. Comparatively, the mounting brackets 233 and 234 of the body panels in FIG. 18, are almost fully inserted over the respective body support brackets 239 and 240 of the respective sub-frame members 235 and 236, resulting in a narrower positioning of the body panels with respect to the truck cab and chassis. A single universal body panel is thereby adjustable to fit truck chassis of a variety of widths, and is also readily removable for replacement or easy access to the chassis and drive train for repairs.

Once the left and right body panels are mounted on the body sub-frame assembly, left deck plates 251 and 252 are connected to each other in an overlapping fashion, as are right deck plates 253 and 254. The connected deck plate assemblies 251, 252 and 253, 254 are mounted to the top surfaces at the inner rear ends of the left and right body panels 231 and 232, respectively, as illustrated in FIG. 16. The amount of overlap between deck panels of a connected pair depends on the width of the particular truck chassis, further increasing the flexibility of fitting universal adjustable body panels on truck chassis of a variety of widths. Alternatively, single left and right deck plates can be cut to size in accordance with the chassis width, and mounted to the top surface at the inner rear ends of the left and right body panels 231 and 232, respectively.

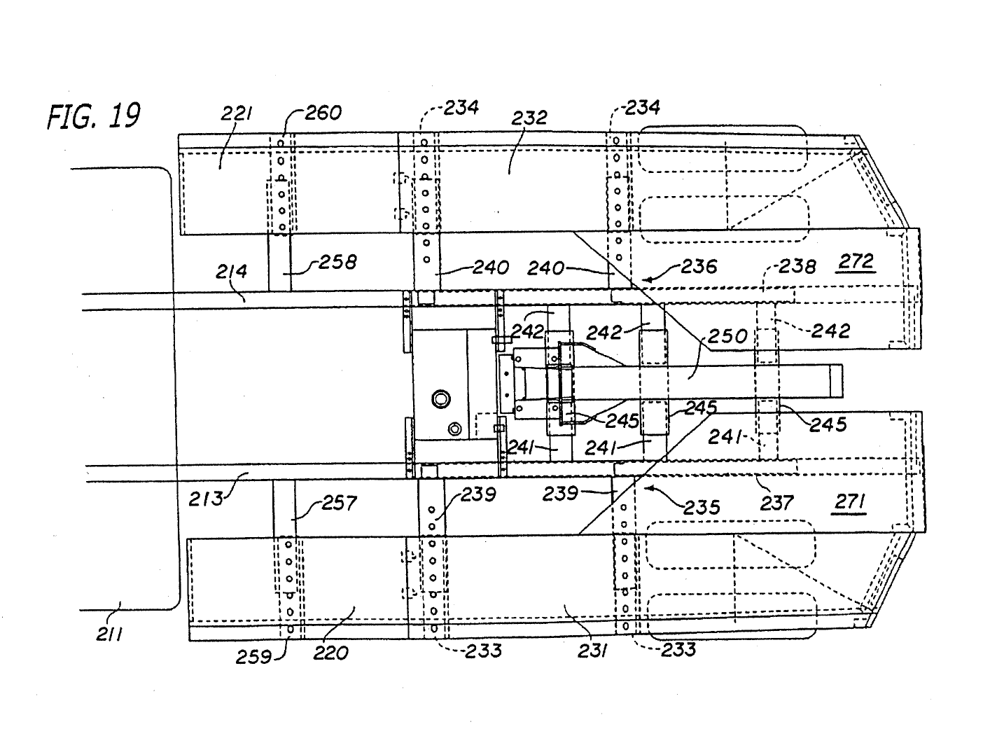

The deck plates form a deck between the respective body panels 231 and 232 and the automobile lift assembly 250. The deck plates or deck plate assemblies can be bolted, welded, riveted, or otherwise fixed together and in place. Alternatively, as shown in FIG. 19, single deck plates 271 and 272, can be integrally provided as part of the respective body panels 231 and 232. The deck plates 271 and 272 are cut to size in accordance with the desired chassis width. Further, left and right length spacer panels 220 and 221, respectively, are cut to size and mounted to the left and right body panels, covering spaces between the left and right body panels 231 and 232, and the truck cab 211. Body support brackets 257 and 258 are fixed to the outer sides of the left and right chassis rails 213 and 214, respectively. The body support brackets 257 and 258 align with mounting brackets 259 and 260 of the left and right length spacer panels 220 and 221, respectively. As with the mounting brackets and body support brackets of the body panels 231 and 232, the mounting brackets 259 and 260, and the body support brackets 257 and 258, each have a series of holes at a predetermined spacing along their length. The predetermined spacing is set such that the holes of a given mounting bracket line up with the holes of the corresponding body support bracket in a manner allowing for various lateral mounting positions for the body panel on the body sub-frame assembly. The various lateral positions are designed to accommodate a number of standard truck chassis and cab widths, and provide for alignment of the length spacer panels 220 and 221 with the respective left and right body panels 231 and 232. Each length spacer panel is positioned on the corresponding body support bracket at a desired lateral position with respect to the respective body panel, and bolted in that position. Further, each length spacer panel is bolted to the respective body panel, as illustrated in FIGS. 16, 18 and 19. The length spacer panels thereby accommodate for a variety of truck chassis lengths upon which the universal adjustable body panels of the present invention can be mounted.

The present invention can be practiced by employing conventional material, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention However, it should be recognized that the present invention can be practiced without resorting to details specifically set forth. In other instances, well known processing structures have not been described in detail, in order not to unnecessarily obscure the present invention.

Only a few embodiments of the present invention are shown and described in the present disclosure. It is to be understood that the present invention is capable of use in various other combinations and environments and is capable of changes or modifications within the scope of the inventive concept as expressed herein.

What is claimed is:

1. A wheel-lift assembly for wreckers for towing a target automobile, the assembly comprising:
a crossbar assembly;
a pair of support arms, each of said support arms being movably attached to the crossbar assembly, the support arms being spaced apart from each other;
a pair of actuating devices connected to said crossbar assembly, each of said actuating devices being operatively connected to one of said support arms; and a pair of over-center locking mechanisms, each connected to said crossbar assembly, to one of
the actuating devices, and to one of said support arms.

2. The wheel-lift assembly of claim 1, wherein each support arm comprises a substantially L-shaped lifting arm having an extension arm segment and an engaging arm segment, said extension arm segment adjustably connected to a respective support arm, each of said engaging arm segments being substantially transverse to the extension arm segment.

3. The wheel-lift assembly of claim 2, further comprising an adjustment mechanism whereby the extension arm segment of each of said lifting arms is adjustable according to the wheel size of the target automobile.

4. The wheel-lift assembly of claim 3, wherein the adjustment mechanism includes a plurality of openings and mating devices, whereby the mating device is inserted into one of said openings to adjust the extension arm segment of each of said lifting arms according to the wheel size of the target automobile.

5. The wheel-lift assembly of claim 2, wherein the extension arm segments are slidably connected to the respective support arms.

6. The wheel-lift assembly of claim 1, wherein the crossbar assembly comprises a crossbar and a pair of opposed grid boxes movably mounted to the crossbar;
wherein the support arms are pivotally attached to the grid boxes; and
wherein each of the overcenter locking devices is connected to one of the grid boxes.

7. The wheel-lift assembly of claim 1, wherein the support arms are pivotally connected to the crossbar assembly;
wherein each of the overcenter locking devices comprises a first and a second link, a first end of the first link being pivotally connected to a first end of the second link, a second end of of the first link being pivotally connected to the crossbar assembly, and a second end of the second link being pivotally connected to one of the support arms, and
wherein one of the actuating devices is pivotally connected between the first and second ends of one of the links.

8. The wheel-lift assembly of claim 6, wherein the support arms are pivotally connected to the grid boxes;
wherein each of the overcenter locking devices comprises a first and a second link, a first end of the first link being pivotally connected to a first end of the second link, a second end of of the first link being pivotally connected to one of the grid boxes, and a second end of the second link being pivotally connected to one of the support arms, and
wherein one of the actuating devices is pivotally connected between the first and second ends of one of the links.

9. The wheel-lift assembly of claim 1, wherein the actuating devices comprise hydraulic cylinders.

10. The wheel-lift assembly of claim 1, wherein said crossbar assembly includes a pivot for mounting the target automobile on the wheel-lift assembly when the length of said target automobile is at an angle of about zero degrees to about ninety degrees from the length of said wrecker.

11. The wheel-lift assembly of claim 1, comprising:
a support member coupled to the wrecker;
a base coupled at a first end to the support member;
a boom base pivotally attached to the base at a first pivot point, the first pivot point located adjacent to a second end of the base opposite to the first end of the base, and adjacent to a first end of the boom base, the boom base having a second end located nearer to the first end of the base than the first end of the boom base;
a boom pivotally attached to the boom base at a second pivot point located further from the first end of the boom base than the first pivot point;
a third actuating device coupled to the support arm and the boom base, wherein the operation of the third actuating device pivots the boom base with respect to the support arm; and
a fourth actuating device coupled to the boom base and the boom;
wherein the operation of the fourth actuating device pivots the boom with respect to the boom base.

12. The wheel-lift assembly of claim 1, comprising an adjustable tow vehicle body sub-frame assembly for mounting on one of a plurality of tow vehicle chassis having different widths, the adjustable body sub-frame assembly including:
left and right sub-frame rails that mount on left and right chassis rails between the outer rear wheels, respectively, each sub-frame rail having at least a first engaging sub-frame element fixed thereto in a lateral direction to the respective chassis rail, and each sub-frame rail having at least one body support element fixed thereto in a lateral direction the respective chassis rail;
a second engaging sub-frame element having two connecting ends, the second sub-frame element connecting to the first sub-frame element of the left sub-frame rail at one connecting end, and connecting the first sub-frame element of the right sub-frame rail to the other connecting end; and
the first sub-frame brace elements being connected at a predetermined distance to the second sub-frame brace element at a position such that each sub-frame rail aligns with the respective chassis rail, and the first sub-frame brace element secured to the second sub-frame brace element at that predetermined position.

13. The wheel-lift assembly of claim 12, including an adjustable body panel comprising:
at least one mounting element fixed to the body panel extending laterally to the body panel, and the one mounting element having spacing along its length;
the one mounting element aligning with the corresponding body support element fixed to the predetermined tow vehicle chassis, the one body support element extending laterally to the chassis, and having spacing along its length; and
the body panel being mountable on the one body support element in one of a plurality of lateral positions, wherein in each such position the spacing of the one mounting element mate with the spacing of the body support element at one of a plurality of positions relative to said widths of the tow vehicle chassis rails.

14. A wheel-lift assembly for wreckers, the assembly comprising:
a crossbar assembly comprising a crossbar and a pair of opposed grid boxes movably mounted to the crossbar;
a pair of support arms, each of said support arms being movably attached to one of the grid boxes, the support arms being spaced apart from each other;
a pair of actuating devices connected to said crossbar, each of said actuating devices being operatively connected to one of said support arms; and
a pair of lifting arms, each of said lifting arms including an extension arm segment and an engaging arm segment, said extension arm segment adjustably connected to one of the support arms, each of said engaging arm segments being substantially transverse to the extension arm segment.

15. The wheel-lift assembly of claim 14, further comprising an adjustment mechanism whereby the extension arm segment of each of said lifting arms is adjustable according to the wheel size of the target automobile.

16. The wheel-lift assembly of claim 15, wherein the adjustment mechanism includes a plurality of openings and mating devices, whereby the mating device is inserted into one of said openings to adjust the extension arm segment of each of said lifting arms according to the wheel size of the target automobile.

17. The wheel-lift assembly of claim 14, wherein the extension arm segments are slidably connected to the respective support arms.

18. The wheel-lift assembly of claim 14, wherein the grid boxes are slidably connected to opposing ends of the crossbar.

19. A wheel-lift assembly for wreckers, the assembly comprising:
a crossbar assembly comprising a crossbar and a pair of opposed grid boxes movably mounted to the crossbar;
a pair of support arms, each of said support arms being movably attached to one of the grid boxes, the support arms being spaced apart from each other;
a pair of actuating devices connected to said crossbar;
a pair of over-center locking mechanisms, each connected to one of the grid boxes, to one of the actuating devices, and to one of said support arms; and
a pair of lifting arms, each of said lifting arms including an extension arm segment and an engaging arm segment, said extension arm segment adjustably connected to one of the support arms, each of said engaging arm segments being substantially transverse to the extension arm segment.

20. A wrecker for towing a vehicle, the wrecker comprising a tow vehicle chassis, a wheel-lift assembly, an adjustable body sub-frame assembly mounted thereon, and an adjustable body panel assembly;
the wheel-lift assembly comprising:
a crossbar assembly comprising a crossbar and a pair of opposed grid boxes movably mounted to the crossbar;
a pair of support arms, each of said support arms being movably attached to one of the grid boxes, the support arms being spaced apart from each other;
a pair of actuating devices connected to said crossbar;
a pair of over-center locking mechanisms, each connected to one of the grid boxes, to one of the actuating devices, and to one of said support arms; and
a pair of lifting arms, each of said lifting arms including an extension arm segment and an engaging arm segment, said extension arm segment adjustably connected to one of the support arms, each of said engaging arm segments being substantially transverse to the extension arm segment;
the adjustable body sub-frame assembly including:
left and right sub-frame rails that mount on left and right chassis rails between the outer rear wheels, respectively, each sub-frame rail having at least a first engaging sub-frame element fixed thereto in a lateral direction to the respective chassis rail, and each sub-frame rail having at least one body support element fixed thereto in a lateral direction the respective chassis rail;
a second engaging sub-frame element having two connecting ends, the second sub-frame element connecting to the first sub-frame element of the left sub-frame rail at one connecting end, and connecting the first sub-frame element of the right sub-frame rail to the other connecting end; and
the first sub-frame brace elements being connected at a predetermined distance to the second sub-frame brace element at a position such that each sub-frame rail aligns with the respective chassis rail, and the first sub-frame brace element secured to the second sub-frame brace element at that predetermined position, and
the adjustable body panel assembly including:
at least one mounting element fixed to the body panel extending laterally to the body panel, and the one mounting element having spacing along its length;
the one mounting element aligning with the corresponding body support element fixed to the predetermined tow vehicle chassis, the one body support element extending laterally to the chassis, and having spacing along its length; and
the body panel being mountable on the one body support element in one of a plurality of lateral positions, wherein in each such position the spacing of the one mounting element mate with the spacing of the body support element at one of a plurality of positions relative to said widths of the tow vehicle chassis rails.
